(19) United States
(12) Patent Application Publication
(10) Pub. No.: US 2026/0120435 A1
(43) Pub. Date: Apr. 30, 2026

(54) METHOD AND SYSTEM FOR TRAINING JIGSAW IMAGE-BASED DEEP LEARNING MODEL, AND METHOD AND SYSTEM FOR DETECTING OUT-OF-DISTRIBUTION OBJECT USING THE SAME

(71) Applicant: GWANGJU INSTITUTE OF SCIENCE AND TECHNOLOGY, Gwangju (KR)

(72) Inventors: Kyoobin LEE, Gwangju (KR); Yeon Guk YU, Gwangju (KR); Min Hwan KO, Gwangju (KR); Sung Ho SHIN, Gwangju (KR)

(73) Assignee: GWANGJU INSTITUTE OF SCIENCE AND TECHNOLOGY, Gwangju (KR)

(21) Appl. No.: 19/003,749

(22) Filed: Dec. 27, 2024

(30) Foreign Application Priority Data
Jun. 26, 2024 (KR) 10-2024-0083274

(51) Int. Cl. G06V 10/774; G06V 10/72; G06V 10/764; G06V 10/776

(52) U.S. Cl. CPC G06V 10/774; G06V 10/72; G06V 10/764; G06V 10/776

(57) ABSTRACT

A method of detecting an OOD object is provided. The method includes: receiving an input image; and recognizing an OOD object from the input image using a pre-trained deep learning model, in which the deep learning model is trained according to a method of training a deep learning model, the method of training a deep learning model including: receiving an original image; transforming unique features represented from the original image to generate a jigsaw image; specifying the jigsaw image as a proxy OOD; and training the deep learning model using the original image and the jigsaw image to recognize the OOD object from the input image.

### DESCRIPTION OF GOVERNMENT-SPONSORED RESEARCH

The present invention was carried out with support from the national research and development project, with the unique project identification number being 1711193916 and the project number being RS-2022-II0951. The project related to the present invention is supervised by the Ministry of Science and ICT, and managed by the Institute of Information and Communications Technology Planning and Evaluation (IITP). The research project is titled “Human-centered Artificial Intelligence Core Technology Development Project,” and the research project is named “Development of Uncertainty-Aware Agents Learning by Asking Questions.” The project executing institution is the Electronics and Telecommunications Research Institute (ETRI), and the research period is from Jan. 1, 2023, to Dec. 31, 2023.

### CROSS REFERENCE TO RELATED APPLICATION

The present application claims priority to Korean Patent Application No. 10-2024-0083274, filed on Jun. 26, 2024, the entire contents of which is incorporated herein for all purposes by this reference.

### BACKGROUND

### Field

The present invention relates to a method and system for training a deep learning model using jigsaw images and detecting an out-of-distribution (OOD) object using the trained model.

### Description of the Related Art

With the advancement of artificial intelligence technology, deep learning models are being widely used in various industries and service fields. A deep learning model is a field of technology that uses artificial neural networks, which mimic the structure of the human brain, to learn data and recognize patterns. Recently, artificial intelligence using deep learning models has begun replacing human tasks and operations, leading to active research on methods to enhance the reliability and performance of artificial intelligence.

The deep learning model processes data using multiple layers of neural networks, and the more layers there are, the greater the model's expressive power, allowing the model to learn more complex patterns and thereby producing highly refined results.

Further, research is also being conducted on methods to prevent deep learning models from overfitting to specific training data, which can lead to learning noise or becoming suitable only for particular datasets, as well as on ways to enhance the reliability of deep learning models.

For example, the deep learning model can be used for tasks such as obstacle recognition during autonomous driving, which requires a high level of reliability comparable to that of a human. Furthermore, there is a need to improve the reliability of deep learning models for performing tasks that require safety and accuracy, such as those in medical artificial intelligence.

Accordingly, the present invention proposes a training method and system for detecting out-of-distribution (OOD) objects using jigsaw images, in order to enhance the reliability of a deep learning model for image classification and meet these needs.

### SUMMARY

The present invention relates to a method and system for training a jigsaw image-based deep learning model to enhance the OOD object detection performance of the deep learning model, as well as to a method and system for detecting an OOD object using the same.

More specifically, the present invention relates to a method and system for training a jigsaw image-based deep learning model capable of distinguishing between an in-distribution (ID) object learned by the deep learning model for image classification and an unlearned OOD object, as well as to a method and system for detecting an OOD object using the same.

To solve the aforementioned objects, the method and system for training a jigsaw image-based deep learning model according to the present invention, as well as the OOD object detection method and system using the same, may train the deep learning model by dividing an original image to generate a jigsaw image, and using both the original image and the jigsaw image to recognize OOD objects from an input image.

To this end, there is provided a method of detecting an OOD object using an OOD object detection system, according to the present invention. The method may include: receiving an input image; and recognizing an OOD object from the input image using a pre-trained deep learning model, wherein the pre-trained deep learning model is trained according to a method of training a deep learning model, the method of training a deep learning model including: receiving an original image; transforming unique features represented from the original image to generate a jigsaw image; specifying the jigsaw image as a proxy OOD; and training the deep learning model using the original image and the jigsaw image to recognize the OOD object from the input image.

In addition, there is provided a system for detecting an OOD object, according to the present invention. The system may include an input unit configured to receive an input image, and a detection unit configured to detect an OOD object from the input image using a pre-trained deep learning model, in which the pre-trained deep learning model may be trained according to a method of training a deep learning model, and the method of training a deep learning model may include: receiving an original image; transforming unique features represented from the original image to generate a jigsaw image; specifying the jigsaw image as a proxy OOD; and training the deep learning model using the original image and the jigsaw image to recognize the OOD object from the input image.

In addition, there is provided a program stored on a computer-readable recording medium, and executed by one or more processes in an electronic device, according to the present invention. The program may include instructions to allow the program to perform: receiving an input image; and recognizing an OOD object from the input image using a pre-trained deep learning model, wherein the pre-trained deep learning model is trained according to a method of training a deep learning model, the method of training a deep learning model including: receiving an original image; transforming unique features represented from the original image to generate a jigsaw image; specifying the jigsaw image as a proxy OOD; and training the deep learning model using the original image and the jigsaw image to recognize the OOD object from the input image.

In addition, there is provided a method of training a deep learning model using a system for training a deep learning model, according to the present invention. The method may include: receiving an original image; transforming unique features represented from the original image to generate a jigsaw image; specifying the jigsaw image as a proxy OOD; and training the deep learning model using the original image and the jigsaw image to recognize the OOD object from the input image.

In addition, there is provided a system for training a deep learning model, according to the present invention. The system may include: an input unit configured to receive an original image; a jigsaw generation unit configured to transform unique features represented from the original image to generate a jigsaw image; and a training unit configured to specify the jigsaw image as a proxy OOD and train the deep learning model using the original image and the jigsaw image to recognize the OOD object from the input image.

In addition, there is provided a program stored on a computer-readable recording medium, and executed by one or more processes in an electronic device, according to the present invention. The program may include instructions to allow the program to perform: receiving an original image; transforming unique features represented from the original image to generate a jigsaw image; specifying the jigsaw image as a proxy OOD; and training the deep learning model using the original image and the jigsaw image to recognize the OOD object from the input image.

As described above, the training method and system for detecting OOD objects according to the present invention may train a deep learning model using an original training image and a jigsaw image, thereby enabling the detection of OOD objects.

Further, the method and system for detecting OOD objects according to the present invention may detect OOD objects with high accuracy using a deep learning model trained in a manner that a jigsaw image generated using an original training image is used as a proxy OOD.

### BRIEF DESCRIPTION OF THE DRAWINGS

FIG. 1A and FIG. 1B are conceptual views for describing the detection of out-of-distribution (OOD) objects in an image classification deep learning model.

FIG. 2A and FIG. 2B are conceptual views of a training system for jigsaw image-based OOD object detection in the present invention.

FIG. 3 is a conceptual view illustrating jigsaw images according to the present invention.

FIG. 4 and FIG. 5 are flowcharts for describing a method of training a jigsaw image-based deep learning model according to the present invention.

FIG. 6A and FIG. 6B are conceptual views for describing a system for detecting an OOD object according to the present invention.

FIG. 7 is a flowchart for describing a method of detecting an OOD object according to the present invention.

FIG. 8 and FIGS. 9A to 9C are conceptual views for describing the performance of a system for training deep learning model and a system for detecting an OOD object according to the present invention.

FIG. 10 is a block diagram illustrating the structure of a computing device that performs a method of training a deep learning model and a method of detecting an OOD object according to the present invention.

### DETAILED DESCRIPTION OF EMBODIMENT

Hereinafter, exemplary embodiments disclosed in the present specification will be described in detail with reference to the accompanying drawings. The same or similar constituent elements are assigned with the same reference numerals regardless of reference numerals, and the repetitive description thereof will be omitted. The suffixes “module”, “unit”, “part”, and “portion” used to describe constituent elements in the following description are used together or interchangeably in order to facilitate the description, but the suffixes themselves do not have distinguishable meanings or functions. In addition, in the description of the exemplary embodiment disclosed in the present specification, the specific descriptions of publicly known related technologies will be omitted when it is determined that the specific descriptions may obscure the subject matter of the exemplary embodiment disclosed in the present specification. In addition, it should be interpreted that the accompanying drawings are provided only to allow those skilled in the art to easily understand the embodiments disclosed in the present specification, and the technical spirit disclosed in the present specification is not limited by the accompanying drawings, and includes all alterations, equivalents, and alternatives that are included in the spirit and the technical scope of the present invention.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element exists between the constituent elements.

Singular expressions include plural expressions unless clearly described as different meanings in the context.

In the present application, it should be understood that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

The present invention aims to improve the detection performance of out-of-distribution (OOD) objects (hereinafter referred to as “objects”) that have not been learned by a deep learning model, by proposing a method of training a deep learning model using jigsaw images as a proxy OOD.

Here, an OOD object may refer to an out-of-distribution object that has not been learned by the deep learning model. For example, an OOD object may include another object (e.g., a cat) excluding a first object, in a deep learning model trained to recognize the first object (e.g., a dog) from an image.

In addition, an ID object may refer to an object belonging to the distribution learned by the deep learning model. For example, an ID object may include the first object in a deep learning model trained to recognize the first object from an image.

In addition, a jigsaw image may be generated by dividing an original image into a plurality of fragment images and changing the positions of the generated plurality of fragment images relative to each other. Such jigsaw images may be used as a proxy OOD during the training process of the deep learning model.

In this case, a proxy OOD may refer to data that does not correspond to (or falls outside of) the classes (or training categories) targeted by the deep learning model. That is, a proxy OOD may refer to training data that includes OOD objects.

Therefore, a deep learning model trained using a proxy OOD may recognize OOD objects from an input image. In this case, recognizing an OOD object may refer to recognizing another object, from the input image, excluding an ID object.

In addition, an original image may be training data used for the training of the deep learning model, and thus, the original image may be labeled as ground-truth ID object data as labeled data.

In this case, ground-truth ID object data may be data corresponding to the classes (or training categories) targeted by the deep learning model.

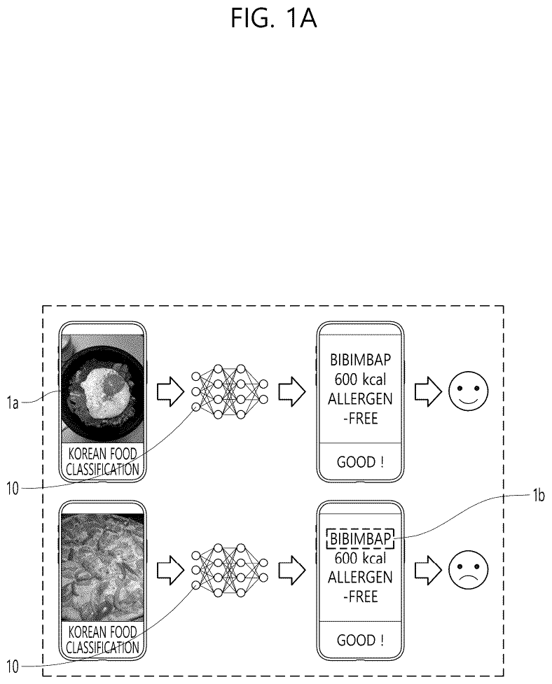

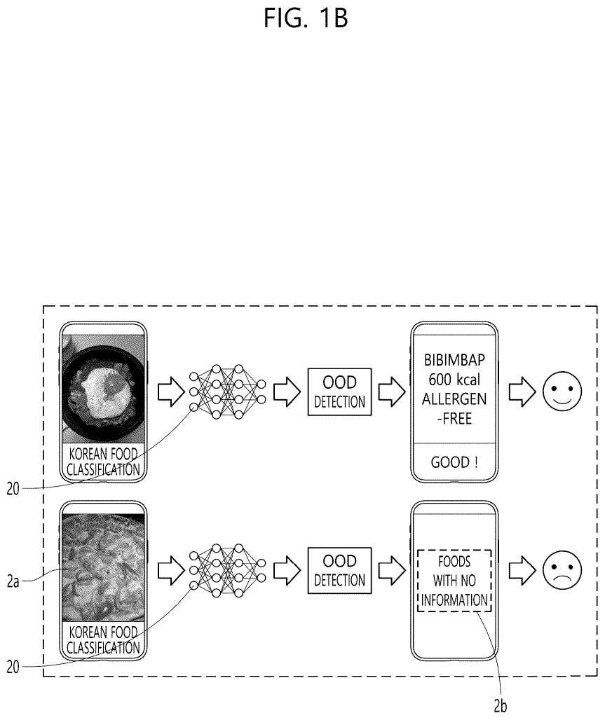

When an unlearned OOD object is input, the deep learning model may experience reduced recognition accuracy, which may pose issues when performing tasks that require high reliability. As illustrated in FIG. 1A, when an image including an OOD object (e.g., a pizza, 1) is input into a deep learning model 10 with poor OOD object detection performance, the deep learning model 10 may output a detection result (e.g., “bibimbap,” 1a) as if the OOD object 1 were an ID object (an in-distribution object learned by the deep learning model). The deep learning model 10 with poor OOD object detection performance may provide incorrect results, making it unsuitable for tasks where reliability is critical.

The system for training a deep learning model according to the present invention may train the deep learning model to accurately detect OOD objects.

As illustrated in FIG. 1B, a deep learning model 20 trained using the method proposed in the present invention may detect an OOD object 2 from an input image and provide an OOD object detection result (e.g., “food with no information,” 2a) as output.

The deep learning model 20 trained using the method proposed in the present invention may not proceed with class classification for the OOD object, even if the OOD object 2 that has not been trained is input.

As described above, the deep learning model 20 trained using the proposed method in the present invention may no longer produce unsuitable results, thereby increasing the reliability of the deep learning model.

Hereinafter, with reference to the attached drawings, a method and system for training a deep learning model using jigsaw images according to the present invention, as well as a method and system for detecting an OOD object using the same, will be described.

In the present invention, training for the deep learning model may be performed using both an original image and a jigsaw image.

Here, the jigsaw image refers to an image formed by transforming the original image into a jigsaw format, and in the present invention, through training for the jigsaw image along with the original image, the OOD object detection performance of the deep learning model may be improved.

The jigsaw transformation of the original image may be understood as dividing the original image into a plurality of fragment counts and randomly changing the positions of the fragments.

Meanwhile, the training images input to the deep learning model may include the original image and the jigsaw image, and hereinafter, to avoid confusion in terminology, the original image will be referred to as an “original training image.”

The system for training a jigsaw image-based deep learning model according to the present invention (hereinafter referred to as a “system 100 for training a deep learning model”) may generate jigsaw images using the original training image, and input both the original training image and the jigsaw image into the deep learning model to perform training for the deep learning model.

In the present invention, training for the deep learning model is performed using the jigsaw image as a proxy OOD, and the deep learning model may enhance its ability to distinguish between an in-distribution (ID) object, which is trained (hereinafter referred to as “ID object”), and an unlearned OOD object.

Here, the ID object refers to an object that has been learned by the deep learning model and may refer to an in-distribution object. Further, the OOD object refers to an object that has not been learned by the deep learning model and may refer to an out-of-distribution object.

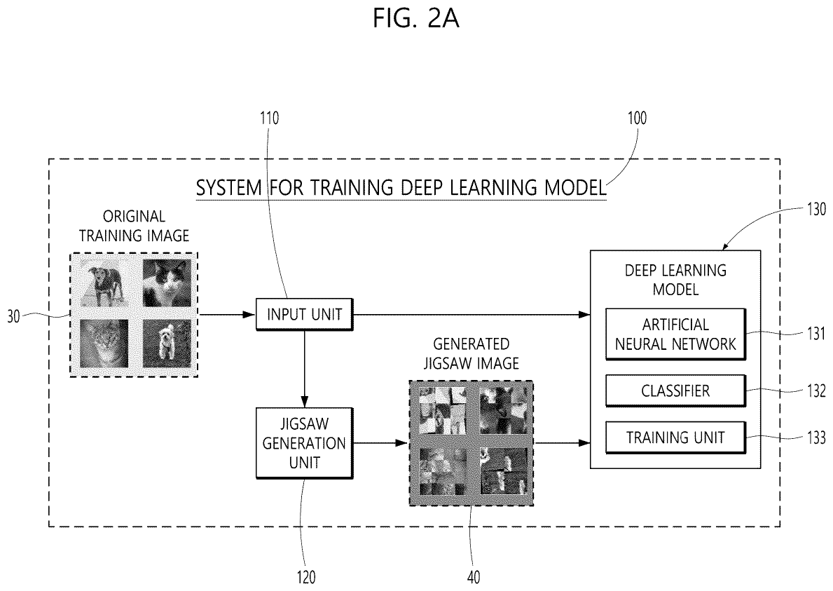

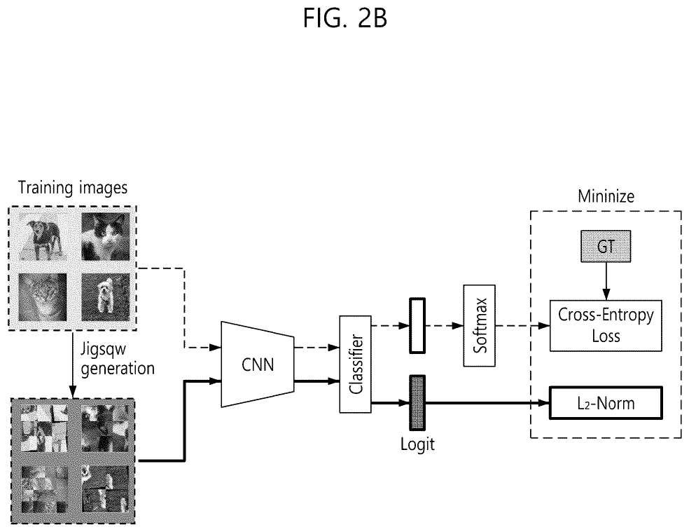

As illustrated in FIG. 2A and FIG. 2B, the system for training a jigsaw image-based deep learning model according to the present invention (hereinafter referred to as the “system 100 for training a deep learning model,”) may include at least one of an input unit 110, a jigsaw generation unit 120, or a deep learning model 130.

The input unit 110 may perform the task of inputting an original training image 30 into the jigsaw generation unit 120 and the deep learning model 130. As described above, the original training image 30 corresponds to the original image of the jigsaw image, and in the present invention, may be collected (or received) from an external server or device. In addition, the original training image 30 may exist to be stored in a training database (DB).

The jigsaw generation unit 120 may generate a jigsaw image 40 using the original training image 30. The jigsaw generation unit 120 may divide the original training image 30 into a plurality of fragment images and randomly change the positions of the plurality of fragment images to generate the jigsaw image 40.

Specifically, the jigsaw generation unit 120 may generate a jigsaw image with a plurality of fragment counts using the original training image 30. For example, the jigsaw generation unit 120 may generate a jigsaw image in a jigsaw form of 2×2, 3×3, 4×4 . . . . N×N, by a preset fragment counts. In this case, the jigsaw generation unit 120 may generate a jigsaw image by changing the positions of the plurality of fragment images according to a preset position change algorithm.

Here, a preset position change algorithm, which is an algorithm for defining to change positions between a plurality of fragment images generated from one original image, may be input to the jigsaw generation unit 120 and may be implemented to exchange a fragment image corresponding to a specific position with a fragment image corresponding to another specific position, depending on the embodiment.

Meanwhile, the deep learning model 130 may be configured to include at least one of an artificial neural network 131, a classifier 132, and a training unit 133.

The artificial neural network 131 may receive at least one of the original image 30 or the jigsaw image 40 as training data as input, and proceed with training to optimize classification and detection capabilities for ID objects and OOD objects.

In the present invention, the artificial neural network 131 may be configured with at least one structure of a CNN structure or other artificial neural network structures, and may receive both the original image and the jigsaw image as inputs to recognize the features of the images and perform the task of extracting patterns.

For example, the artificial neural network 131 may be a convolutional neural network (CNN), and the CNN may perform training on the original training image and the jigsaw image.

The CNN, which is an artificial neural network mainly used for image processing, may be configured with convolution layers and pooling layers.

Here, the convolution layer of the CNN may extract features and patterns from the input image, while the pooling layer may perform the task of reducing the spatial size of the features and patterns extracted by the convolution layer, thereby decreasing the calculation load.

The artificial neural network 131 may be trained to classify the original training image 30 into the classes targeted by the deep learning model 130.

Further, the artificial neural network 131 may be trained using the jigsaw image 40 as a proxy OOD. The artificial neural network 131 may perform training for OOD object detection using the jigsaw image as a proxy OOD.

Here, the term “proxy OOD” may refer to data that does not correspond to (or falls outside of) the classes (or training categories) targeted by the deep learning model.

Meanwhile, the classifier 132 may be configured to perform the role of classifying an object included in the original image or jigsaw image into at least one of a plurality of classes.

In FIG. 2A, the artificial neural network 131 and the classifier 132 are shown separately for convenience of description, but artificial neural network 131 and classifier 132 may be configured to perform the same function. Accordingly, the functions performed by the classifier 132, as described hereinafter, may also be described as being performed by the artificial neural network 131.

The classifier 132 may be configured to classify the original training image or jigsaw image into at least one of a plurality of classes using various algorithms.

The type of classifier 132 included in the system 100 for training a deep learning model according to the present invention may vary.

More specifically, the classifier 132 may receive at least one pattern of the original training image or the jigsaw image as input from the artificial neural network 131. As described above, the artificial neural network 131 may extract features of the original training image and the jigsaw image to recognize patterns.

Based on the recognized patterns, the classifier 132 may output the logits of the original image and the jigsaw image.

Meanwhile, the training unit 133 may proceed with the training process so that the artificial neural network 131 learns both the original image and the jigsaw image.

The training unit 133 may perform training through different data processing for each of the original image and the jigsaw image.

In this case, the training unit 133 may perform the training data processing for the original image and the training data processing for the jigsaw image in either parallel (simultaneously) or sequentially.

The training unit 133 may perform training on the artificial neural network 131 through the training on the original training image 30 to improve the classification performance of ID objects in the deep learning model.

The training unit 133 may perform training on the original training image 30 so that the error (or error value) between the ground truth class (ground truth, GT) of the objects included in the input image and the specific class classified by the artificial neural network 131 is minimized.

Specifically, the training unit 133 may use a softmax function and the cross-entropy loss function to perform the task of minimizing the difference between the logit norm of the original training image 30 and the data (ground truth) of the actual class that the deep learning model attempts to predict.

Therefore, the training unit 133 may train the deep learning model so that the original training image 30 may be classified into a ground truth class.

Further, for OOD object detection, the training unit 133 may repeatedly perform the task of assigning low probability values to the jigsaw image 40 to proceed with training on the artificial neural network 131.

The training unit 133 may further perform the task of training the jigsaw image 40 to have a low logit norm value, using an L2 loss function between the class of the jigsaw image 40 and the ground truth class.

In the present invention, the norm may be understood as representing the magnitude of a specific vector or matrix. Further, the logit norm may be understood as the magnitude of a probability vector used for classification and OOD object training for at least one of the original training image 30 or the jigsaw image 40.

Meanwhile, the training unit 133 may use a proxy OOD-based outlier exposure method.

Here, the term “proxy OOD-based outlier exposure method” refers to a method in which the deep learning model is trained to assign low probability values to the proxy OOD in the training phase. In the present invention, the deep learning model may be trained to detect OOD objects by assigning low probability values to the jigsaw image.

In addition, the training unit 133 may perform training using the proxy OOD-based outlier exposure method and the L2 loss function by repeating the process to make the logit norm value of the jigsaw image become zero, so that the training unit 133 may minimize the loss value for the jigsaw image output by the classifier 132.

As previously described, in the system 100 for training a deep learning model according to the present invention, training on the deep learning model 130 may be performed using the jigsaw image.

In the present invention, the trained deep learning model 130 may be used to detect OOD objects from an input image. In this case, the “input image” may also be referred to as a “test image” and hereinafter, will be used interchangeably.

The deep learning model 130 trained by the learning method proposed by the present invention may, when an OOD object (see reference numeral “2” in FIG. 1A and FIG. 1B) is included in an input image, provide an OOD object detection result (e.g., “food with no information”, 2a) as an output.

As described above, the deep learning model 130 trained with the method proposed in the present invention does not output incorrect results for unlearned OOD objects, and may provide highly reliable object detection performance.

Hereinafter, a more detailed description will be provided regarding a method of training a deep learning model using jigsaw images to enhance OOD detection performance, as well as a method of detecting OOD objects using the trained deep learning model.

The system 100 for training a deep learning model in the present invention may generate the jigsaw image 40 associated with the original training image 30 using the original training image.

In the present invention, the jigsaw image 40 may refer to an image that is formed by transforming the original training image 30 into a jigsaw format.

In the present invention, the system 100 for training a deep learning model may transform unique features of the original training image 30 (e.g., the usual structure that constitutes an object or features that distinguish a specific object from other objects) during the process of transforming the original training image 30 into a jigsaw format.

Specifically, in the present invention, when the system 100 for training a deep learning model divides the original training image 30 into a plurality of fragments and randomly changes the positions of the fragments, unique features of an object in the original training image 30 (e.g., “giraffe's neck,” “lion's mane,” etc.) may be lost.

As described above, the jigsaw generation unit 120 may generate a plurality of fragment images by dividing the original image into a preset number of fragments. Accordingly, the jigsaw generation unit 120 may generate a jigsaw image by changing the positions of the plurality of fragment images according to a preset position change algorithm.

Further, the preset position change algorithm may be implemented to exchange a fragment image corresponding to a specific position with a fragment image corresponding to another specific position.

In addition, the jigsaw generation unit 120 may generate a plurality of replicated images by replicating the original image using the preset position change algorithm, and may generate different plurality of jigsaw images using each of the plurality of replicated images.

That is, the jigsaw generation unit 120 may divide each replicated image into a preset number of fragments to generate a plurality of fragment images, and then change the positions of the plurality of fragment images according to the preset position change algorithm to generate jigsaw images.

In this case, the jigsaw generation unit 120 may change the positions of the fragment images in different ways for each of the plurality of replicated images.

Specifically, the jigsaw generation unit 120 may apply the position change algorithm to each of the plurality of replicated images a different number of times to generate different plurality of jigsaw images, or may change the positions of the plurality of fragment images generated from each of the plurality of replicated images differently, thereby generating different plurality of jigsaw images.

Meanwhile, the jigsaw generation unit 120 may also generate different plurality of jigsaw images by designating different numbers of the plurality of fragment images to be divided from each of the plurality of replicated images. As previously described, the number of fragment images may be preset and present in the jigsaw generation unit 120, and the jigsaw generation unit 120 may change the preset number of fragment images.

The system 100 for training a deep learning model according to the present invention may use the jigsaw image 40 as a proxy OOD, maintaining information on objects such as color and texture of the original training image 30 while dismantling the unique meaning of the original training image 30.

The jigsaw image 40, even if the unique meaning of the objects in the original training image 30 is dismantled, includes all constituent parts of the objects in the original training image 30, so that the deep learning model 130 may be trained to detect an OOD object including identical or similar features to those in the original training image 30 when the OOD object is input.

As previously described, since the jigsaw image 40 may be used as an effective proxy OOD for OOD object detection in the system 100 for training a deep learning model according to the present invention, it may be understood that the jigsaw image 40 is used during the training of the deep learning model 130.

For example, in a deep learning model that classifies images of a “dog,” when an image of a “lion” is used as a proxy OOD for OOD object detection training, the background information such as texture and color may differ, but the features of the object such as body structure like eyes, nose, mouth, and tail may be similar.

Accordingly, since the “lion” image has a similar body structure to the “dog,” which is the original training image 30, using the lion image as a proxy OOD may negatively affect the performance improvement of OOD object detection.

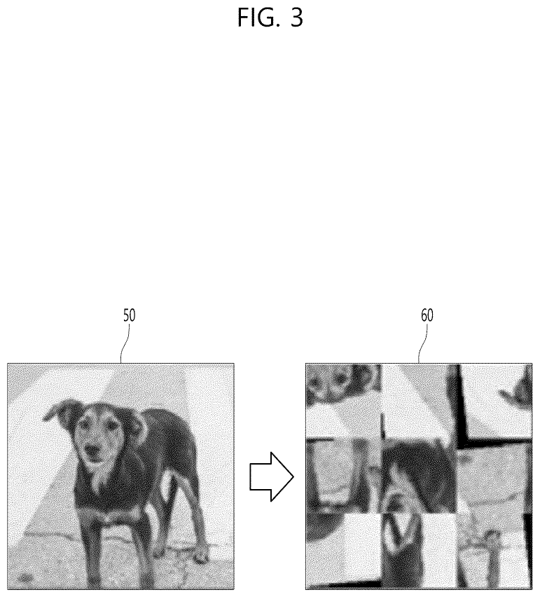

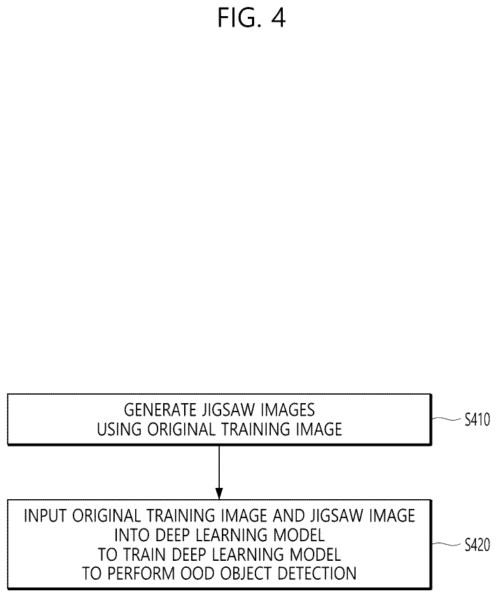

In contrast, as illustrated in FIG. 3, to generate a jigsaw image 60 of the dog, the original training image 50 of the dog is divided into a plurality of fragment images, and the unique features of the original dog image may be dismantled in the process of randomly changing the position, but the OOD object detection performance may be improved when the jigsaw image 60 of the dog, which includes all the information on the dog, is used as a proxy OOD.

Specifically, since the jigsaw image 60 of the dog does not include unique features such as the arrangement structure of the eyes, nose, mouth, etc. of the original dog image 50, the system 100 for training a deep learning model for dog classification based on the jigsaw image 60 of the dog may train the deep learning model to detect the lion image as an OOD object that includes features similar to the dog image.

In addition, since the system 100 for training a deep learning model based on the jigsaw image 40 uses a transformation of the original training image 30, there is no need to additionally collect or receive image data from other classes to be used as a proxy OOD, and thus may have simpler and more efficient features.

Hereinafter, the OOD object training process using the jigsaw image 40 in the system 100 for training a deep learning model according to the present invention will be described.

The system 100 for training a deep learning model of the present invention may train a deep learning model 130 to perform OOD object detection using the jigsaw image 40 generated from the original training image 30.

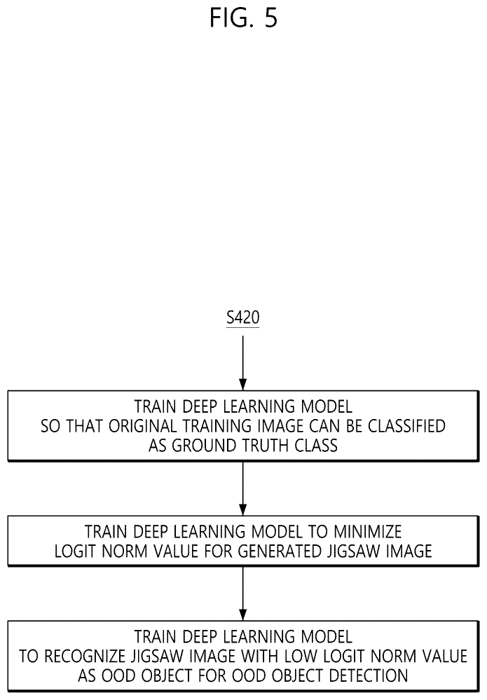

Specifically, the jigsaw image 40 generated by the jigsaw generation unit 120 and the original training image 30 may be input together into the deep learning model 130 to train the deep learning model 130 to perform OOD object detection (S420, see FIG. 5).

The system 100 for training a deep learning model according to the present invention may input the original training image 30 into the artificial neural network 131 and output a logit for a specific class corresponding to the original training image 30 using the artificial neural network 131 and the classifier 132.

The system 100 for training a deep learning model may use the softmax function, which converts the logits into a class-wise probability distribution.

Further, the system 100 for training a deep learning model may perform the task of generating a vector that represents a probability for a specific class based on a class-wise probability distribution of the logits.

Meanwhile, the deep learning model 130 may use a cross-entropy loss function for the original training image 30 and the ground truth class.

Using this, the system 100 for training a deep learning model may perform the task of reducing the error between the logit norm of the original training image 30 and the ground truth class vector magnitude, thereby minimizing the cross-entropy loss.

Furthermore, the system 100 for training a deep learning model may train the deep learning model 130 to classify images of the same class as the original training image 30 into the ground truth class by minimizing the cross-entropy loss.

More specific details will be described with reference to Equation 1 and Equation 2 below.

$$softmax ( {z}_{i} ) = \frac{{e}^{{Z}_{i}}}{{\sum }_{j = 1}^{K} {e}^{{Z}_{j}}} \qquad Equation 1$$

Here, Zᵢ is the i-th element of the input vector for the softmax function, K is the number of classes, and the system 100 for training a deep learning model may use the softmax function to convert each element of the input vector Z into an exponential function, and then divide by the total sum to create a probability distribution.

Specifically, the system 100 for training a deep learning model according to the present invention may perform the task of converting the input vector of a specific class classified from the original training image 30 into a probability distribution using the softmax function.

$$CE = - {\sum }_{i = 1}^{c} {y}_{i} log ( {p}_{i} ) \qquad Equation 2$$

Here, C represents the number of classes, yᵢ is a vector converted from categorical data of the ground truth class into numerical form, and pᵢ may be understood as the probability for the class predicted by the model.

The probability distribution for the class of the original training image 30 predicted by the deep learning model 130 has an increasing probability value as it approaches the ground truth class, and an increase in the probability value may be understood as a decrease in a cross-entropy loss value.

Further, by repeating the training process described above to minimize the cross-entropy loss, the system 100 for training a deep learning model according to the present invention may proceed with training the deep learning model 130 to classify the original training image 30 into the ground truth class.

Meanwhile, the system 100 for training a deep learning model according to the present invention may further use the original training image 30 to perform the process of training using the generated jigsaw image 40 as a proxy OOD.

Specifically, the system 100 for training a deep learning model may input the jigsaw image 40 into the artificial neural network 131, and use the proxy OOD-based outlier exposure method along with the L2 loss function.

Further, the system 100 for training a deep learning model may train the deep learning model 130 by repeatedly performing the process of ensuring that the jigsaw image 40 has a low logit norm value.

Through the training process described above, the deep learning model 130 assigns a low probability value to the jigsaw image 40, and using this, the model may be trained so that OOD objects are not classified into the same class as the original training image 30.

More specific details are described with reference to Equation 3 below.

$$L 2 LOSS = \frac{1}{N} {\sum }_{i = 1}^{N} {\hat{y}}_{i}^{2} \qquad Equation 3$$

Here, N may be understood as the number of data points, and ŷᵢ may be understood as a prediction vector value of the deep learning model.

In the present invention, the system 100 for training a deep learning model may use the L2 loss function and the outlier exposure method for the jigsaw image 40 that has been classified into a specific class, and perform the process of assigning a low probability value to the class of the predicted jigsaw image 40 until the logit norm value of the jigsaw image 40 becomes zero.

Further, the system 100 for training a deep learning model may proceed with training by repeating the process above to minimize a loss value for the jigsaw image 40.

As described above, the system 100 for training a deep learning model for OOD object detection according to the present invention may calculate a final loss value for the deep learning model 130 during the training process, using the cross-entropy loss of the original training image 30 and the L₂ loss value for the jigsaw image 40.

More specific details are described with reference to Equation 4 and Equation 5 below.

$${L}_{ce} = {E}_{( x , y ) ∼ {D}_{in}} [ log ( {p}_{y} ) ] {L}_{norm} = {E}_{( x ) ∼ {D}_{jigsaw}} {‖ v ‖}_{2}^{2} \qquad Equation 4$$

$$L = {L}_{ce} + λ {L}_{norm} \qquad Equation 5$$

Here, L_{ce} represents a cross-entropy loss of the original training image calculated in Equation 2, and Lₙₒᵣₘ represents an L₂ loss for the jigsaw image calculated in Equation 3.

In Equation 5, a weight is set as λ=1, and the system 100 for training a deep learning model may obtain a final loss value L for the deep learning model 130, and may perform an repeated training process to minimize the final loss L.

Specifically, in the system 100 for training a deep learning model according to the present invention, as the final loss value L decreases, the original training image 30 may be trained to be classified into the ground truth class, while the jigsaw image 40 may be trained to be detected as an OOD object.

In this regard, the system 100 for training a deep learning model may train the deep learning model by, when a predetermined image is input to the deep learning model, deriving logits to recognize OOD objects from the corresponding image, and deriving a reference threshold value o to remove unnecessary elements from the derived logits.

Specifically, the deep learning model may have features such that for the largest value of elements of a specific class of the original image, the model has high confidence in the class to which the model is directed, but low confidence starting with the second largest value.

Therefore, based on the features, the system 100 for training a deep learning model may derive the reference threshold value a for removing values that are not significant to the detection process among the logits derived from the original image.

In this case, the reference threshold value may be calculated as the average of the second largest element in the logits of the original image derived through the deep learning model.

Therefore, when the deep learning model removes values from the logits that are less than or equal to the reference threshold value a, the deep learning model may ignore small values that do not contribute to the final detection determination in detection, thereby enhancing the OOD object detection performance.

More specific details are described with reference to Equation 6.

$$α = \frac{1}{N} {\sum }_{i = 1}^{N} {\hat{v}}_{i} \qquad Equation 6$$

Here, N represents the number of original training images, and \hat{v}ᵢ represents the second largest value in the i-th logit.

In the present invention, the reference threshold value α derived from Equation 6 serves as a criterion for removing small values from the logits of an image that are not to be considered during OOD object detection, thereby improving the performance of the deep learning model.

Further, the system 100 for training a deep learning model may remove values less than or equal to the reference threshold value α derived from Equation 6 from the logits derived from the original image, calculate the norm of the logits with the values removed, and train the deep learning model to recognize ID objects and OOD objects based on the calculated norm of the logits.

That is, the deep learning model may specify whether the previously calculated norm of the logits corresponds to an ID object or an OOD object based on a specific threshold value.

To this end, the system 100 for training a deep learning model may train the deep learning model through the process of deriving a specific threshold value t when a recognition rate of the ID object for the deep learning model satisfies a predetermined recognition rate, by comparing whether the object specified from the norm of the logits is an ID object with the ground-truth ID object data labeled in the original image.

As described above, the specific threshold valuer, which is the criterion for detecting OOD objects (or, ID objects) for the logit norm derived from the original image, may be understood as a threshold value set for detecting OOD objects as the value of the logit norm when 95% of the ID object images are correctly classified by the deep learning model.

Therefore, the system 100 for training a deep learning model may train the deep learning model to detect as an OOD object when the logit norm value derived from the predetermined image based on the reference threshold value α is less than or equal to a specific threshold valuer derived by the deep learning model, and to detect as an ID object when the logit norm value is greater than the specific threshold valuer.

More specific details are described with reference to Equation 7.

$$G ( x ; f ) = \{ \begin{matrix}ID & if {‖ ReLU ( v - α ) ‖}_{2}^{2} > τ \\ OOD & otherwise\end{matrix} \qquad Equation 7$$

Here, x represents an input test image, f represents the deep learning model 130 being trained by the system 100 for training a deep learning model, and

$${‖ v ‖}_{2}^{2}$$

represents a logit norm value of an original image.

Meanwhile, the ReLU function used in Equation 7 is an activation function mainly used in a deep learning model, which may not be used in the training process of the deep learning model, and a detection system 200, which will be described below, may use the ReLU function to output a value of zero when the input value is less than zero, and to output the input value as it is when the input value is greater than zero.

Hereinafter, the OOD object detection system 200 that detects OOD objects using the trained deep learning model 130 and the detection process will be described.

In the present invention, the OOD object detection system 200 may perform the task of detecting whether an input image is an OOD object using the deep learning model 130 trained in the system 100 for training a deep learning model.

Here, the input image includes at least one of the ID object or OOD object, and may be classified as one of the ID object or OOD object by the OOD object detection system 200.

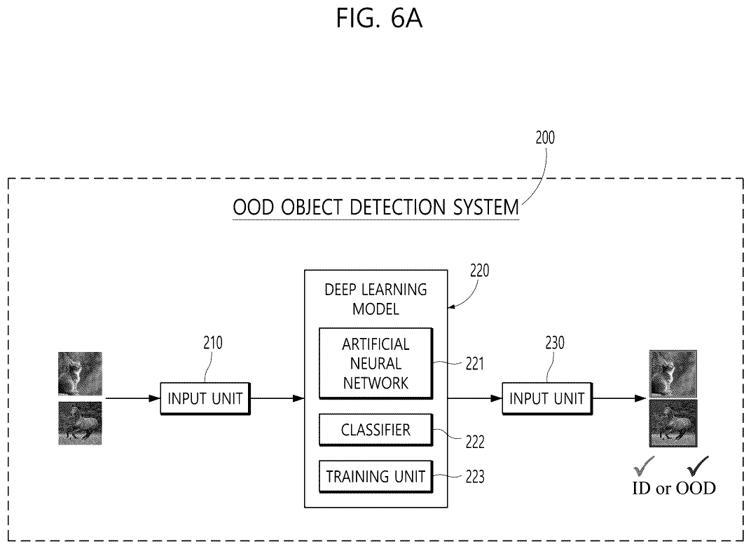

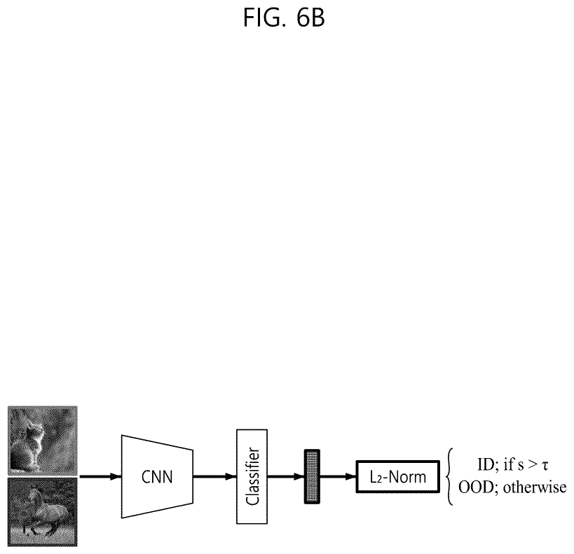

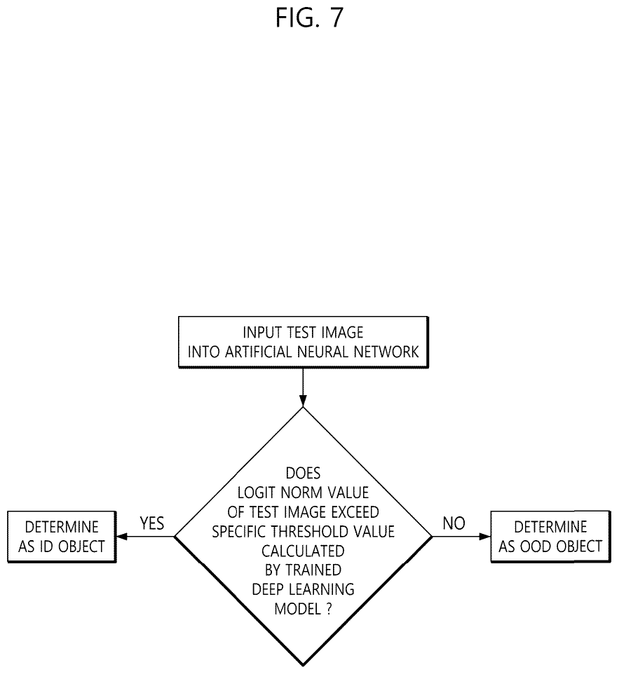

As illustrated in FIG. 6A and FIG. 6B, the OOD object detection system (hereinafter referred to as “detection system”, 200) according to the present invention may include at least one of an input unit 210, a deep learning model 220, or an output unit 230.

The input unit 210 may be connected via a wireless or wired network with servers, devices, and the like, to receive an input image to be detected as an OOD object, and may input the received input image into an artificial neural network 221.

Meanwhile, the deep learning model 220 may be configured to include at least one of an artificial neural network 221, a classifier 222, or a detection unit 223.

In accordance with the present invention, the artificial neural network 221 and the classifier 222 may use the artificial neural network 131 and the classifier 132 trained by the system 100 for training a deep learning model of the present invention.

Meanwhile, the artificial neural network 221 may be used in the process of detecting ID objects and OOD objects for the input image. As described above, the artificial neural network 221 may be configured with at least one structure of a CNN structure or other artificial neural network structures, and may perform the task of extracting features and patterns from the received test image.

Meanwhile, the classifier 222 may also perform the same function as the classifier 132 described above, and may be configured to serve to classify the test image into at least one of a plurality of classes.

In FIG. 6A, the artificial neural network 221 and the classifier 222 are shown separately for convenience of description, but artificial neural network 221 and classifier 222 may be configured to perform the same function. Accordingly, the functions performed by the classifier 222, as described hereinafter, may also be described as being performed by the artificial neural network 221.

Meanwhile, the detection unit 223 according to the present invention may perform the task of detecting whether the input test image is an OOD object.

Specifically, the detection system 200 may use a specific threshold value α derived from the original training image 30 and a specific threshold value ó derived from the system 100 for training a deep learning model to perform OOD object detection on the test image. As described above, in the detection system 200, the o value is the average of the second largest element in the logits of all training images, which may be understood as a specific threshold value set for correct classification of classes. In addition, the t value may be understood as a logit norm value when 95% of ID object images are correctly classified by the deep learning model 130 trained by the system 100 for training a deep learning model of the present invention, and a specific threshold value set for detecting OOD objects.

Meanwhile, the output unit 230 may output a final detection result of the detection unit 223 to a specific user terminal or computer device using a network.

Hereinafter, a more detailed description will be provided regarding a method of detecting OOD objects using the specific threshold values described above in the trained deep learning model 220.

The detection system 200 according to the present invention may receive an input image and perform the task of detecting an OOD object from the received input image.

Specifically, the detection system 200 may perform a detection task to identify whether an OOD object is recognized for the input image using the deep learning model 130 trained by the system 100 for training a deep learning model.

Therefore, the trained deep learning model 130 may, upon an input test image being input through the detection system 200, derive the logits for the input test image, remove at least some values from the previously derived logits according to a pre-trained reference threshold value a, derive the norm of the logits with the at least some values removed, and compare the previously derived logit norm value with a pre-trained specific threshold valuer to specify whether the test image corresponds to an OOD object.

That is, the deep learning model may specify that an ID object is recognized from the input image when the previously derived logit norm value is higher than the specific threshold valuer, and that an OOD object is recognized from the input image when the previously derived logit norm value is lower than the specific threshold value τ.

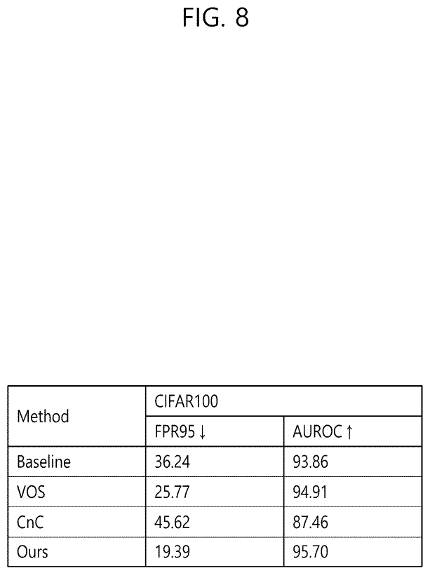

With reference to FIG. 8, the results for the detection performance for semantically shifted OOD objects may be understood. Here, the term “semantically shifted” for an OOD object may be understood as the semantic information that the target of the image carries has changed compared to the training image, and the semantically shifted OOD object has features that are harder to detect than the non-semantically shifted OOD object, such as texture or color.

Accordingly, when the performance of detecting the semantically shifted OOD objects is high, it may be understood that the performance of the OOD object detection method and system is high.

In the present invention, to evaluate the performance of detecting semantically shifted OOD objects, the OOD object detection deep learning model may be trained using CIFAR10, an image dataset with 10 different semantic meanings (or 10 different classes), and then proceed with the task of evaluating OOD object detection on CIFAR100, a dataset with 100 different semantic meanings.

The method allows for evaluating whether the deep learning model trained on 10 classes can perform OOD object detection on 90 semantically changed classes, thereby evaluating the OOD object detection performance.

As illustrated in FIG. 8, among the evaluation methods, “FPR95\” indicates the false positive rate (FPR) when the true positive rate (TPR) is 95%, and it can be seen that the present invention has the lowest value in the “FPR951” performance evaluation, which may be understood that the jigsaw image-based method of the present invention has the best performance in detecting semantically shifted OOD objects.

In addition, among the evaluation methods, AUROC↑ (Area Under the Receiver Operating Characteristic curve) refers to the area under the ROC curve, where the X axis is set as FPR and the Y axis is set as TPR, and it may be understood that the closer the value for the area is to 100, the better the performance.

Similar to the results of the FPR95↓ method described above, it can be seen that the jigsaw image-based method according to the present invention has the highest value, and it may be understood that the deep learning model of the present invention evaluated by the AUROC method has the best performance.

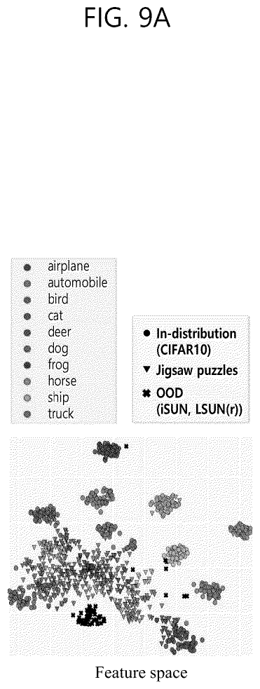

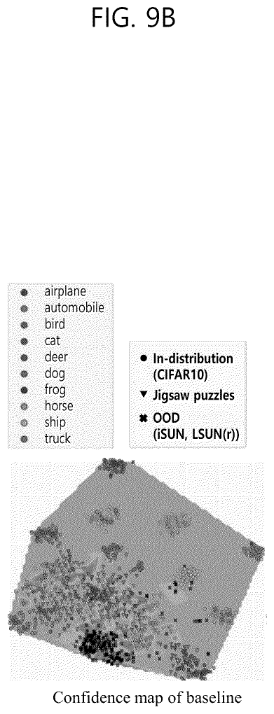

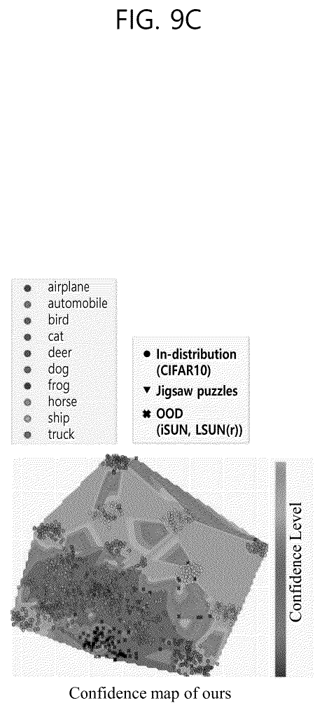

Meanwhile, with reference to FIGS. 9A to 9C to see another performance result, the OOD object detection result using jigsaw images may be visually understood. Specifically, in FIGS. 9A to 9C, the areas represented in yellow indicate high confidence, while the areas represented in blue indicate low confidence.

As illustrated in FIGS. 9A to 9C, when comparing the OOD object detection method and system using the jigsaw image of the present invention with the reference detection method and system, it may be understood that both the reference method and the present invention have high confidence in the detection performance for the ID object image, as the area around the in-distribution (ID) objects in the confidence map is represented by the yellow area.

Meanwhile, in the detection performance of OOD objects, unlike the reference method and system that assigns high confidence to OOD objects, it can be seen that the present invention assigns low confidence to OOD objects, as represented by the blue area around the OOD objects in the confidence map of the present invention.

This allows the test image to be detected as an OOD object rather than being classified into a class targeted by the image classification deep learning model.

As described above, a method and system for detecting OOD objects using a jigsaw image according to the present invention may generate a jigsaw image from an original training image, use the generated jigsaw image as a proxy OOD, and train a deep learning model to detect OOD objects.

Further, in the present invention, the OOD object detection method and system using jigsaw images has the effect of increasing the reliability of the image classification deep learning model through the process of performing the OOD object detection task on the test image by the deep learning model trained by the OOD object detection learning system 100.

Further, the system 100 for training a deep learning model and OOD object detection system 200 according to the present invention may be configured with a computing device to perform at least one function related to the aforementioned method of training a deep learning model and method of detecting an OOD object.

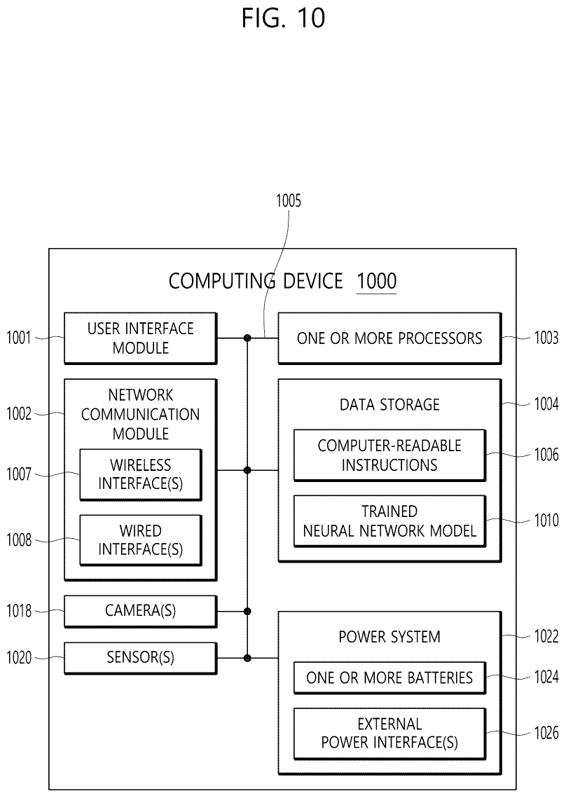

FIG. 10 is a block diagram illustrating the structure of a computing device that performs a method of training a deep learning model and a method of detecting an OOD object according to the present invention.

The computing device 1000 may include a user interface module 1001, a network communication module 1002, one or more processors 1003, data storage 1004, one or more cameras 1018, one or more sensors 1020, and a power system 1022, all of which may be interconnected via a system bus, network, or other connection mechanism 1005.

The user interface module 1001 may be operable to transmit data to and/or receive data from external user input/output devices.

For example, in the present invention, the receipt of the original image by the system 100 for training a deep learning model, or the receipt of the input image by the OOD object detection system 200, may be performed through external input using a user interface module.

In this case, the user interface module 1001 may include a touchscreen, computer mouse, keyboard, keypad, touchpad, trackball, joystick, voice recognition module, or other similar devices.

In addition, the user interface module 1001 may also be configured to provide output to one or more user display devices, such as a cathode ray tube (CRT), liquid crystal display (LCD), light-emitting diode (LED), display using digital light processing (DLP) technology, or a printer.

The user interface module 1001 may also be configured to generate audible output using devices such as speakers, speaker jacks, audio output ports, audio output devices, earphones, and/or other similar devices.

The user interface module 1001 may further configured with one or more haptic devices capable of generating tactile output, such as vibration and/or other forms of output, detectable by touch and/or physical contact with the computing device 1000.

The network communication module 1002 may include one or more devices that provide one or more wireless interfaces 1007 and/or one or more wired interfaces 1008, which can be configured to communicate over a network.

In addition, the network communication module 1002 may be configured to provide secure and/or authenticated communication that is reliable.

The one or more processors 1003 may include one or more general-purpose processors and/or one or more special-purpose processors (e.g., digital signal processors, tensor processing units (TPUs), graphics processing units (GPUs), neural processing units (NPUs), application-specific integrated circuits (ASICs), or application-specific semiconductors, etc.). The one or more processors 1003 may be configured to execute computer-readable instructions 1006 included in the data storage 1004 and/or other commands described in the present specification.

As such an example, the training and inference described in the present specification may be executed on a neural processing unit (NPU) to enhance efficiency by performing data calculation processing with high speed and low power consumption.

The data storage 1004 may include one or more non-transitory computer-readable storage media that are readable and/or accessible by at least one of the one or more processors 1003.

The one or more computer-readable storage media may include volatile and/or non-volatile storage constituent elements, such as optical, magnetic, organic, or other memory or disk storage devices. In some examples, the data storage 1004 may be implemented using a single physical device (e.g., one optical, magnetic, organic, or other memory or disk storage device), whereas in other examples, the data storage 1004 may be implemented using two or more physical devices.

The data storage 1004 may include computer-readable instructions 1006 as well as additional data. The data storage 1004 may include storage necessary to perform at least part of the methods, scenarios, and technologies described in the present specification and/or at least part of the functions of the devices and networks.

In some examples, the data storage 1004 may include a storage for the trained neural network model 1010 described in the present invention (e.g., deep learning model).

Meanwhile, the computing device 1000 may include one or more cameras 1018, one or more sensors 1020, and/or a power system 1022.

The camera(s) 1018 may capture light and/or electromagnetic radiation emitted as visible light, infrared radiation, ultraviolet light, and/or one or more other frequencies of light. The sensor 1020 may be configured to measure conditions within the computing device 1000 and/or conditions in the environment of the computing device 1000 and provide data regarding these conditions. The power system 1022 may include one or more batteries 1024 and/or one or more external power interfaces 1026 to provide power to the computing device 1000.

Meanwhile, the above description explains the implementation of the system 100 for training a deep learning model and the OOD object detection system 200 of the present invention as a computing device, but the present invention is not limited thereto. For example, the functionality of the neural network and/or computing device may be distributed among a plurality of computing clusters.

Meanwhile, the present invention described above may be executed by one or more processes on a computer and implemented as a program that can be stored on a computer-readable medium (or recording medium).

Further, the present invention described above may be implemented as computer-readable code or instructions on a medium in which a program is recorded. That is, the present invention may be provided in the form of a program.

Meanwhile, the computer-readable medium includes all kinds of storage devices for storing data readable by a computer system. Examples of computer-readable media include hard disk drives (HDDs), solid state disks (SSDs), silicon disk drives (SDDs), ROMs, RAMs, CD-ROMs, magnetic tapes, floppy discs, and optical data storage devices.

Further, the computer-readable medium may be a server or cloud storage that includes storage and that the electronic device is accessible through communication. In this case, the computer may download the program according to the present invention from the server or cloud storage, through wired or wireless communication.

Further, in the present invention, the computer described above is an electronic device equipped with a processor, that is, a central processing unit (CPU), and is not particularly limited to any type.

Meanwhile, it should be appreciated that the detailed description is interpreted as being illustrative in every sense, not restrictive. The scope of the present invention should be determined on the basis of the reasonable interpretation of the appended claims, and all of the modifications within the equivalent scope of the present invention belong to the scope of the present invention.

What is claimed is:

1. A method of detecting an OOD object using an OOD object detection system, comprising:
receiving an input image; and
recognizing an OOD object from the input image using a pre-trained deep learning model,
wherein the pre-trained deep learning model is trained according to a method of training a deep learning model, the method of training a deep learning model including:
receiving an original image;
transforming unique features represented from the original image to generate a jigsaw image;
specifying the jigsaw image as a proxy OOD; and
training the deep learning model using the original image and the jigsaw image to recognize the OOD object from the input image.

2. The method of claim 1, wherein the generating of the jigsaw image includes:
dividing the original image to generate a plurality of fragment images; and
changing positions of the plurality of fragment images to generate the jigsaw image.

3. The method of claim 1, wherein the training of the deep learning model includes:
specifying ground-truth ID object data, which is label data for the original image, as an ID object;
specifying the jigsaw image as a proxy OOD; and
training the deep learning model using the original image, the ground-truth ID object data, and the jigsaw image.

4. The method of claim 1, wherein the deep learning model is trained to:
identify whether the OOD object is recognized from the input image; and
recognize an ID object from the input image based on the identification result.

5. The method of claim 4, wherein the deep learning model is trained to:
output an recognition result for the OOD object as an output corresponding to the input image when it is identified that the OOD object is recognized from the input image; and
recognize an ID object from the input image and output the recognized ID object when it is identified that the recognition of the OOD object from the input image has failed.

6. A system for detecting an OOD object, comprising:
an input unit configured to receive an input image; and
a detection unit configured to detect an OOD object from the input image using a pre-trained deep learning model,
wherein the pre-trained deep learning model is trained according to a method of training a deep learning model, the method of training a deep learning model including:
receiving an original image;
transforming unique features represented from the original image to generate a jigsaw image;
specifying the jigsaw image as a proxy OOD; and
training the deep learning model using the original image and the jigsaw image to recognize the OOD object from the input image.

7. A program stored on a computer-readable recording medium, and executed by one or more processes in an electronic device, the program comprising instructions to allow the program to perform:
receiving an input image; and
recognizing an OOD object from the input image using a pre-trained deep learning model,
wherein the pre-trained deep learning model is trained according to a method of training a deep learning model, the method of training a deep learning model including:
receiving an original image;
transforming unique features represented from the original image to generate a jigsaw image;
specifying the jigsaw image as a proxy OOD; and
training the deep learning model using the original image and the jigsaw image to recognize the OOD object from the input image.

8. A method of training a deep learning model using a system for training a deep learning model, comprising:
receiving an original image;
transforming unique features represented from the original image to generate a jigsaw image;
specifying the jigsaw image as a proxy OOD; and
training the deep learning model using the original image and the jigsaw image to recognize the OOD object from the input image.

9. A system for training a deep learning model, comprising:
an input unit configured to receive an original image;
a jigsaw generation unit configured to transform unique features represented from the original image to generate a jigsaw image; and
a training unit configured to specify the jigsaw image as a proxy OOD and train the deep learning model using the original image and the jigsaw image to recognize the OOD object from the input image.

10. A program stored on a computer-readable recording medium, and executed by one or more processes in an electronic device, the program comprising instructions to allow the program to perform:
receiving an original image;
transforming unique features represented from the original image to generate a jigsaw image;
specifying the jigsaw image as a proxy OOD; and
training the deep learning model using the original image and the jigsaw image to recognize the OOD object from the input image.
